(19) United States
(12) Patent Application Publication
(10) Pub. No.: US 2026/0147776 A1
(43) Pub. Date: May 28, 2026

(54) CONVERSION OF FREE-TEXT NATURAL LANGUAGE QUESTIONS TO STRUCTURED DATA QUERIES FOR DATABASE SEARCHING USING LARGE LANGUAGE MODELS

(71) Applicant: NICE LTD., Ra'anana (IL)

(72) Inventors: Peter LIFSHITS, Kedumim (IL); Adi VATURI, Ein Vered (IL)

(21) Appl. No.: 18/958,629

(22) Filed: Nov. 25, 2024

(51) Int. Cl. G06F 16/2458; G06F 40/30; G06F 40/40

(52) U.S. Cl. CPC G06F 16/2458; G06F 40/30; G06F 40/40

(57) ABSTRACT

A question processing system and methods are provided that are configured to intelligently generate structured data queries from natural language questions using a large language model (LLM). The system includes a processor and a computer readable medium operably coupled thereto, the computer readable medium comprising a plurality of instructions stored in association therewith that are accessible to, and executable by, the processor, to perform operations which include receiving a natural language question for structured data including columns having discrete text values, generating, using an LLM, a first structured data query having a predicted text value, searching a data store for similar ones of the discrete text values, generating, using the LLM, a second structured data query that refines the first structured data query based on the similar discrete text values, and querying a structured database based on the first and/or second structured data query.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to large language models (LLMs) and other artificial intelligence (AI) systems and models, and more specifically to a system and method for automatically generating structured data queries from natural language questions using an LLM to identify initial discrete data values and refine queries using semantically similar values.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

With the advent of LLMs, service providers have increasingly utilized LLMs for simplified data retrieval by allowing users to utilize natural language to request answers from a knowledge base, such as corpora of documents on which the LLM may be trained. As such, translation of free-text natural language questions to structured queries (e.g., in a query language, such as structured query language (SQL), Elasticsearch Query Language (ES QL), etc.) has conventionally been provided only for simple static database schemas, which enables some users that are not data analysts to query structured data from structured databases without knowledge of a query language. However, columns in structured databases may have discrete sets of values that may either be too large to be provided in a prompt to an LLM or the values may vary depending on other criteria (e.g., per tenant, per vertical, changes with time, etc.) or the values may vary too significantly, which may create difficulties when determining the correct value from natural language. If the user does not provide the exact value to check for, the translation process may be required to “guess” or predict the value, which often creates an incorrect query and the user may not obtain the desired data.

As such, when translation processes converse with users in natural language, but data is stored in a structured format, several issues may arise from the differences in structure, syntax, semantics, and the like with discrete values in certain columns. As such, conventional translation processes are not fully capable of directly using natural language questions for structured data querying. For example, with contact center analytic databases, one of the columns and corresponding data variables may be a set of agent skills, which may change per tenant and their requisite or tracked agent metrics. Further, the columns may include a set of call categories and/or intents, which may include hundreds of values and/or change with time and per vertical. As such, when searching for a specific type of call, the user may be required to know the exact internal name of that type of call, as well as the specific identifier of the calls.

This knowledge is generally impractical for users that are contact center managers and leaders, not data analysts, as they are unlikely to have been exposed to the particular data and data storage paradigm in place of more common or colloquial names of the calls and/or call types. Thus, service providers may be required to determine whether the question asked can be answered using the structured data and, if not, what are the correct or even best question and data values to search the structured data (e.g., in database tables and the like). Consequently, it is desirable to provide a process for generating and refining, procedurally with no or minimal user input and manual efforts, structured data queries for specific discrete values, for example, using LLMs or other generative AIs. Therefore, there is a need for an automated, intelligent, and efficient computing system and framework that can convert natural language questions to structured query languages and structured data queries for specific discrete values in structured databases.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified system architecture of a question processing system for query generation operations that may generate structured queries from natural language questions using an LLM with a data store of discrete text values according to some embodiments.

FIG. 3 is a simplified diagram of the software components executed by the system architecture in FIG. 2 for query generation of structured queries from natural language questions according to some embodiments.

FIG. 4 is a simplified diagram of a processing flow for query generation operations to generate structured queries from natural language questions according to some embodiments.

FIG. 5 is a simplified user interface where a user may ask natural language questions for querying a structured database according to some embodiments.

FIG. 6 is a simplified diagram of an exemplary flowchart for converting free-text natural language questions to structured queries using an LLM with discrete text values from a data store according to some embodiments.

FIG. 7 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

A service provider may provide a question processing system for generating structured data queries from natural language questions, which may be utilized for applications that respond to questions from users in natural language. Those applications may require that the questions are answered from, and therefore queried and/or searched against, a structured database or other structured data storage system. The question processing system may include and/or be provided per application, tenant, structured database and/or data type, and/or role/user-specific characteristic or identifier. Questions may be asked in natural language but correspond to a discrete value stored in a structured database, such as in structured data tables having columns for those discrete values. As such, discrete values may correspond to data that may only take a certain value and may be measurable as a limited number of values and/or categories. In this regard, a question in natural language may ask “How may calls by team A open accounts?” A discrete value requested by the user for a “Call Type” column may be “Create Account.”

When responding to questions, the question processing system may proceed through a multi-prompt process using at least two different prompts to an LLM, which may be done to initially obtain a “guess” at the discrete value being requested by the user, or a probable discrete value that has been requested by the user for searching the database. When a user asks a question, the question in its natural language form may be sent to the LLM in a first prompt with a corresponding database schema for the structured database. The first prompt may further include an instruction or a request to create the structured query (e.g., SQL query for an SQL database). The prompt may be sent via one or more application programming interface (API) calls, which may be done according to a prompting strategy. The schema may include information including the list of tables and columns, as well as a basic description of the tables, columns, data, or the like. As such, if the question was “Number of opening account calls made,” the structured query may be generated to include a clause: CallType=‘Open Account’ and the value ‘Open Account’ may therefore be guessed by the LLM.

The system may parse the resulting query and extract a string literal of “Open Account.” A search may then be performed of a discrete value data store, which may store the discrete values as vectors in a vector database, for semantically similar discrete values, or for any discrete value column. In this regard, only columns with discrete values may be checked against the vector database. Any similar vectors, such as the N closest vectors and/or vectors within a similarity threshold or distance (e.g., as measured by a similarity calculation in vector space, such as cosine similarity, Euclidean distance, etc.), may be identified from the data store. Those vectors with a distance less than or equal to the threshold may be retrieved, such as, in the above example, a column ‘CallType’ may have semantically close or similar values ‘Create Account’ and ‘Account Updates,’ and the column ‘CallOutcome’ may have a value ‘Ticket Opened’.

Thereafter, a second prompt to the LLM in one or more subsequent API calls may add the columns with the corresponding discrete values identified. This prompt may therefore provide additional context and allow the LLM to more accurately create a structured query. As such, in response to the second prompt, the structured query may include a clause: CallType=‘Create Account’. Thereafter, the query may be sent to the structured database and structured query search system for execution. A query result may be returned, and the query result may include the retrieved data values and other information from executing the query. A response to the user's natural language question may be generated and provide the results and relevant values that were searched and/or that were identified from comparing the guessed data value by the LLM to the data values in the data store. As such, the user may be hinted at possible changes to rephrase the question as needed. The prompting at both stages may be based on the users/organization configuration preferences and structured data systems so that responses may be generated in the desired format for the structured data.

As such, an intelligent system according to the present disclosure is provided to solve various issues with natural language searches of structured data, LLM conversion of natural language to structured language for data query and storage, and manual generation of structured queries. User therefore may not need to utilize unfamiliar, time consuming, and/or unintuitive systems when compared to natural language and may utilize simplified search systems in a more convenient and efficient manner. This may be done using GPT-4 or other generative pretrained transformers (GPTs), LLMs, or the like, to provide conversational and/or generative AI services. By leveraging LLMs, generative AI services may provide natural language processing capabilities, allowing prompting for responses that analyze and interpret large amounts of data with accuracy and speed. LLMs and other generative AI may learn on past data use when providing structured query generation, such as which queries were successful or not in returning the proper structured data to natural language questions, and therefore may provide processes to continually learn and update structured query generation processes.

A computing service and framework may be coded, deployed, and made available to users that automatically generates structured queries from natural language questions using LLMs (e.g., aGPT, such as GPT-4), or the like with a data store of vectors, embeddings, or other searchable representations of discrete values. The embodiments described herein provide methods, computer program products, and computer database systems for a machine learning (ML) or other AI system that programmatically processes, evaluates, and responds to natural language questions with structured data from structured querying. The framework of intelligent automation for query generation may therefore provide data searching and retrieval operations in a faster, more efficient, and more convenient manner, providing intuitive questioning using natural language in place on more obscure and technical query languages. This provides an improved data searching, storage, and retrieval system with better compatibility and more convenient and efficient searching.

According to some embodiments, ML algorithms, features, and models are provided of a question processing system for providing structured queries and/or structured query searching from natural language questions intelligently and automatically, thereby providing faster, more efficient, and more precise query generation and/or data retrieval operations.

### Example System and Computing Environment

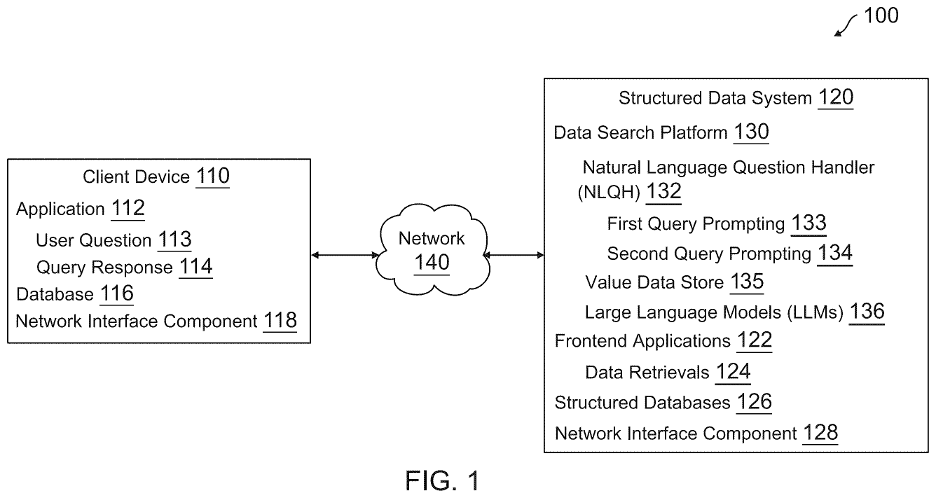

The system and methods of the present disclosure can include, incorporate, or operate in conjunction with, or in the environment of, an ML engine, model, and intelligent system, which may include an ML or other AI computing architecture that provides structured query generation and/or searching for natural language questions from users. Such structured query generation and/or searching may be performed using LLMs by prompting such LLMs in multiple stages or phases, where a data store of discrete values may be used to refine initial LLM responses for structured query generation. FIG. 1 is a block diagram of a networked environment 100 suitable for implementing the processes described herein according to an embodiment. As shown, environment 100 may include or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or lesser number of devices and/or servers. For example, ML models, NNs, and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a structured data system 120 that interact over a network 140 to provide intelligent querying of structured databases and data storage systems using natural language questions from users through structured query generation and/or execution, as discussed herein. In other embodiments, environment 100 may not have all of the components listed and/or may have other elements instead of, or in addition to, those listed above. In some embodiments, environment 100 is an environment in which a data search platform 130 may perform data searches and/or retrieval from structured databases 126 using structured queries, where such queries may be generated from natural language questions using data search platform 130. As illustrated in FIG. 1, structured data system 120 might interact via a network 140 with client device 110 to provide data searching and retrieval services through data search platform 130, which may include natural language processing of search queries for structured data.

For example, in structured data system 120, frontend applications 122 may provide and/or process data from data storage components and systems, including structured databases 126. As such, frontend applications 122 may consume and/or output data that results from structured data searching and querying of structured databases 126. To do so, data search platform 130 may provide operations to allow for natural language questions and other inputs to be used in place of structured data queries that require formatting and structuring in a query language, such as SQL, ES QL, and the like. Instead, data search platform 130 may convert natural language inputs to structured queries by generating queries using a natural language question handler (NLQH) 132 that may perform a multiple LLM prompting process. This prompting process may generate structured data queries through a first query prompting 133 and/or a second query prompting 134, which may be used with a value data store 135.

When a user question 113 is received from an application 112 on client device 110, NLQH 132 may process user question 113 to determine and provide a query response 114. NLQH 132 may perform first query prompting 133 based on user question 113 and a database schema for structured databases 126 to determine an initial or first structured data query. First query prompting 133 may correspond to LLM prompting, such as calling with text or questions in natural language and/or other input with a corresponding instruction (e.g., to generate the first structured data query) that requests an output based on the provided input. The calls may be made via API calls to LLMs 136 and/or their corresponding LLM interfaces, applications, or the like. The database schema for one or more of structured databases 126 may include tables, columns, and basic descriptions of data views and definition, data tables, data source names, and/or information and/or explanations of columns.

User question 113 may correspond to a natural language question or other input, which may therefore be required to be processed to perform structured querying of structured databases 126 for the data requested by user question 113. User question 113 may be received via frontend applications 122 during use of one or more applications by client device 110. Frontend applications 122 may be integrated with and/or capable of calling (e.g., using one or more application programming interface (API) calls) data search platform 130 for data querying and retrieval of structured data from structured databases 126 using LLMs 136. As such, data search platform 130 may utilize NLQH 132 with LLMs 136 to generate structured queries, as discussed herein. After generating of the first structured data query from first query prompting 133, NLQH 132 may parse the query and determine the discrete values for string literals used for structured querying of structured databases 126.

Thus, after first query prompting 133, one or more initial discrete values for a structured query may be determined, predicted, and/or guessed by LLMs 136. Value data store 135 may be used to identify actual discrete values and/or column identifiers for discrete values. Value data store 135 may include the discrete values, column names and/or identifiers, data table information, and/or metadata for structured databases 126 and/or structured data stored to structured databases 126. The discrete values stored by value data store 135 may include vectors or embeddings of the discrete values, such as names or identifiers of categorical discrete values. These embeddings may correspond to vectors or other mathematical representations of one or more words or string of characters for discrete values, and may be used to compare and match, procedurally using a similarity comparison operation (e.g., cosine similarity, Euclidean distance, etc.), the predicted discrete values from first query prompting 133 to actual discrete values for structured data stored by structured databases 126.

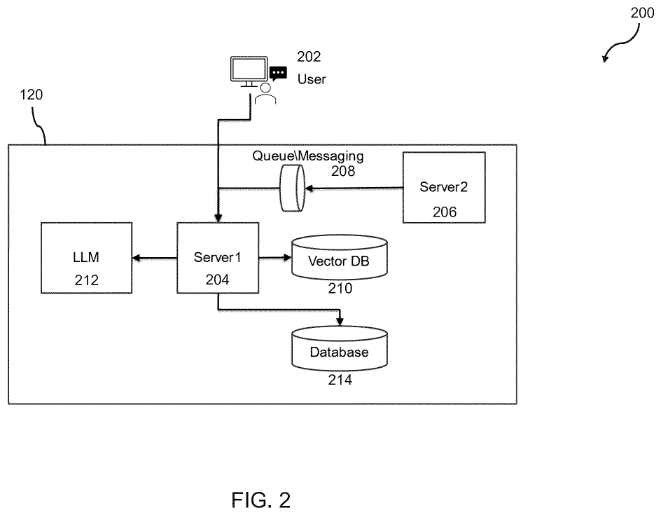

As such, NLQH 132 may perform a comparison and lookup of semantically similar discrete values from value data store 135. This may be done through vector comparison and similarity algorithms and techniques. If any values are the same or sufficiently similar, the first data query may be executed on structured databases 126. However, if other discrete data values are determined from value data store 135 to be similar to the first structured data query generated from first query prompting 133, but multiple different values are found and/or not sufficiently similar to be considered the same for structured querying, then second query prompting 134 may be performed to generate a more refined and accurate structured data query. The second data query generated from second query prompting 134 by prompting LLMs 136 based on user question 113, the first generated query and/or string literals/discrete values from that query, the identified discrete values from value data store 135 that are semantically similar to the discrete values from the first generated query, and/or the database schema. A second structured query may be generated and may be utilized for structured data searching and querying on structured databases 126. These queries may be executed on structured databases 126, which may respond with data retrievals 124 for structured data responsive to user question 113. Thereafter, query response 114 may be generated based on data retrievals 124, and query response 114 may be output in application 112 based on retrieved data 124. Thus, structured data system 120 may be utilized to provide ML operations to tenants, customers, and other users or entities via frontend applications 122 for data retrieval from structured databases 126 using natural language inputs. The operations to generate structured queries by prompting an LLM are discussed in more detail with regard to FIGS. 2-7 below.

Data search platform 130 may leverage generative AIs, LLMs, GPTs including GPT-4, or other models to integrate such models for generative AI services. Data search platform 130 may not rigidly specify a specific generative AI model, permitting generative AI models, LLMs, GPTs, or the like to be modularly added or removed based on changes and advancements. Further, data search platform 130 may not be restricted to calling generative AI services and LLMs once or a limited number of times, and queries and/or responses from natural language inputs may be generated piece-by-piece or by providing examples, although single calls may be preferred in certain embodiments. For LLMs 136 and other ML models (e.g., decision trees and corresponding branches, NNs, clustering operations, etc.) including those used by data search platform 130, the models may be trained using training data, which may correspond to stored, preprocessed, and/or feature transformed data associated with pre-generated questions, metadata, queries, query responses, or the like, as well as other conversational skills. With continuous and/or reinforcement training, live streaming data from one or more production, live, and/or real-time computing environments may be used, as well as feedback from different entities. Model training and configuring may include performing feature engineering and/or selection of features or variables used by ML models. Features or variables may correspond to discrete, measurable, and/or identifiable properties or characteristics.

LLMs, ML modes, and NNs used by structured data system 120 may be trained using one or more ML algorithms, operations, or the like for modeling (e.g., including configuring decision trees or neural networks, weights, activation functions, input/hidden/output layers, and the like). Thus, one or more ML models, NNs, or other AI-based models and/or engines may be trained for structured query generation and/or execution from natural language questions and other inputs, or another ML task. The training data may be labeled or unlabeled for different supervised or unsupervised ML and NN training algorithms, techniques, and/or systems. Structured data system 120 may further use features from such data for training, where the system may perform feature engineering and/or selection of features used for training and decision-making by one or more ML, NN, or other AI algorithms, operations, or the like (e.g., including configuring decision trees, weights, activation functions, input/hidden/output layers, and the like). A model may then be trained using a model training function and/or algorithm for the model trainer. The training may include adjustment of weights, activation functions, node values, and the like. After initial training of models, models may be evaluated and/or released in a production computing environment. For example, LLMs may be used to provide conversational AI skills and performance, which may utilize training and a knowledge base to respond to queries and other prompts from users.

One or more client devices and/or servers (e.g., client device 110 using application 112) may execute a web-based client that accesses a web-based application for structured data system 120, or may utilize a rich client, such as a dedicated resident application, to access structured data system 120, which may be provided by frontend applications 122 to such client devices and/or servers. Client device 110 and/or other devices or servers may utilize one or more application programming interfaces (APIs) to access and interface with frontend applications 122 and/or data search platform 130 of structured data system 120 in order to access, review, and evaluate question and query responses, as discussed herein. Interfacing with structured data system 120 may be provided through frontend applications 122 and/or data search platform 130, which may be based on data stored by structured databases 126 of structured data system 120 and/or a database 116 of client device 110.

Client device 110, structured data system 120, and/or other devices and servers on network 140 might communicate using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and structured data system 120 may occur over network 140 using a network interface component 118 of client device 110 and a network interface component 128 of structured data system 120 and corresponding interfaces, connections, and the like. In an example where HTTP/HTTPS is used, client device 110 might include an HTTP/HTTPS client for application 112, commonly referred to as a “browser,” for sending and receiving HTTP//HTTPS messages to and from an HTTP//HTTPS server, such as structured data system 120 via the network interface component.

Similarly, structured data system 120 may host an online platform accessible over network 140 that communicates information to and receives information from client device 110. Such an HTTP/HTTPS server might be implemented as the sole network interface between client device 110 and structured data system 120, but other techniques might be used as well or instead. In some implementations, the interface between client device 110 and structured data system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with structured data system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet, network 140 may correspond to such a network using the TCP/IP protocol for data transfer. However, it should be understood that the networks that the present embodiments might use are not so limited, although TCP/IP is a frequently implemented protocol. Further, one or more of client device 110 and/or structured data system 120 may be included as part of the same system, server, and/or device and therefore communicate directly or over an internal network.

According to one embodiment, structured data system 120 is configured to provide webpages, forms, applications, data, and media content to one or more client devices and/or to receive data from client device 110 and/or other devices, servers, and online resources. In some embodiments, structured data system 120 may be provided or implemented in a cloud environment, which may be accessible through one or more APIs with or without a corresponding graphical user interface (GUI) output. Structured data system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for frontend applications 122 and/or data search platform 130 of structured data system 120, such as during structured data querying of structured databases 126. In one embodiment, client device 110 includes application servers configured to implement and execute software applications as well as provide related data, code, forms, webpages, platform components or restrictions, and other information, and to store to, and retrieve from, a database system related data, objects, and web page content. For example, structured data system 120 may implement various functions of processing logic and processing components, and the processing space for executing system processes, such as running applications. Client device 110 and structured data system 120 may be accessible over network 140. Thus, structured data system 120 may send and receive data to client device 110 via network interface components 128 and 118, respectively. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients. Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to structured data system 120 that provides one or more APIs for interaction with client device 110.

Thus, client device 110 and/or structured data system 120 and all of their components might be operator configurable using application(s) including computer code to run using a central processing unit, which may include an Intel Pentium® processor or the like, and/or multiple processor units. A server for client device 110 and/or structured data system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and structured data system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Structured Data Query System

FIG. 2 is a simplified system architecture 200 of a question processing system for query generation operations that may generate structured queries from natural language questions using an LLM with a data store of discrete text values according to some embodiments. System architecture 200 of FIG. 2 includes a representation of the components utilized for structured data querying on structured databases from natural language questions and other inputs, which may be performed by structured data system 120 using data search platform 130 discussed in reference to environment 100 of FIG. 1. In this regard, system architecture 200 displays the components that interact when generating structured data queries using a multi-prompting process that may utilize initial determinations of discrete values by an LLM to determine whether other semantically similar discrete values exist, and if so, utilize those values to refine the initial determination of a structure data query and discrete values for a more accurate structured data query.

In this regard, user 202 may interact with an application/service of structured data system 120, such as one or more of frontend application 122 that provide search functionalities and/or data search platform 130, to submit questions, requests, and other inputs to be queried on structured data stored by a database 214 or other structured data storage system (e.g., structured databases 126). These inputs may be provided in a natural language format, such as standard English or other language. As such, the application/service of structured data system 120 may correspond to any such software application and/or computing service that may convert natural language to SQL or other structured data language for querying on structured databases (e.g., databases or other data storage systems storing structured data in data tables and views including columns and rows that are searchable using structured data queries in a specific format). This may be done through query translation, which may utilize predicted discrete values with known discrete values for multiple LLM prompting that refines structured data query through multiple iterations and converts natural language questions to structured queries.

The application/service usable by user 202 for structured data querying using natural language questions may be deployed in any platform including cloud computing platforms and providers, on-premises applications/services, hybrid type deployments, and the like. As such, the application/service, and its corresponding components shown in system architecture 200, may be callable from another application or endpoint via one or more API calls exchanged between corresponding APIs. Initially, a device, server, or other endpoint usable by user 202 may call a first server 204, which may correspond to a server or other component that runs the main logic for the application/service and performs structured query generation. A second server 206 may manage user defined values and publish changes in configurations of structured data and/or structured databases as events to a queueing/messaging system 208. For example, a user administrator or other end user may be capable of defining definitions, data values, column names (e.g., classifiers, groups, or other names/identifiers of groups of data values), and the like for different structured data to be stored. With regard to call or contact centers, which may handle incoming and outgoing calls between agents and customers, such definitions may include call types, call classifications, agents, teams, hierarchies, and the like. Once there is a new record for a definition, or an edit to an existing definition, second server 206 may push an event to queueing/messaging system 208. Using the pushed event, queueing/messaging system 208 may receive the event and generate a new data value or edit an existing data value, which may be updated with a vector database (DB) 210.

As such, vector DB 210 may include discrete data values and/or representations of such values, such as in a data store accessible and searchable by the components in system architecture 200. Vector DB 210 may allow for correlation and/or comparison to predicted or guessed data values by an LLM 212. Vector DB 210 may store pre-generated vectors and/or embeddings of the discrete data values from columns in structured data, as well as column names or identifiers, which may be usable for discrete value lookup and/or correlation through matching and/or comparison, such as cosine similarity or other assessment of an accuracy of matching between vectors for embeddings. Thus, vector DB 210 may be utilized by first server 204 to provide data for converting natural language inputs to structured data queries by enabling first server 204 to look up and identify semantically similar data values for structured query generation. The data values and/or their vector representations stored by vector DB 210 may correspond to structured data stored by database 214. Vector DB 210 may correspond to any database that supports embeddings and/or vector storage, as well as an embedding vector search. Thus, vector DB 210 may store possible discrete data values for discrete columns of the supported schema with vector embeddings of the discrete data values. Vector DB 210 may partition and/or store the values and vector embeddings for each combination of tenant, table, and/or column. Database 214 may correspond to a structured database, such as an SQL database or the like that may include the corresponding structured data. As such, database 214 may store core business data or other data that is searchable in structured data form.

LLM 212 may be provided and/or utilized by the application/service for responding to user questions in a more optimized manner. LLM 212 may provide generative AI capabilities as part of an internal or external component for the application/service and its corresponding service provider. For example, Azure Open AI with GPT-4 or GPT-35-Turbo-16k may be used, although other LLMs may also be trained and used, as described herein. As such, LLM 212 may be trained to translate and/or convert text to SQL or other structured language used by database 214 for structured data querying. LLM 212 may be provided by a third-party service and/or vendor, or instead may be proprietarily trained and provided by structured data system 120.

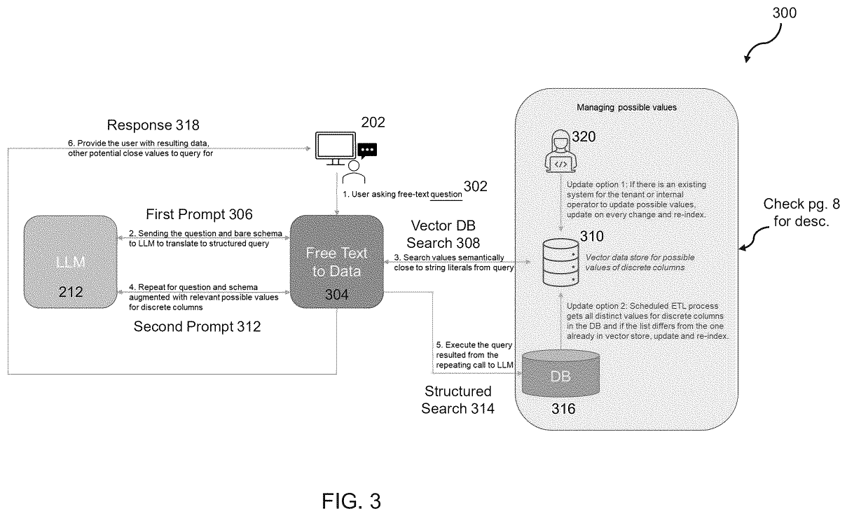

Thus, when user 202 interacts with first server 204 via a device and/or application, first server 204 may execute the main logic to generate structured data queries using LLM 212. First server 204 may support Representational State Transfer (REST) APIs, which may pass a request from user 202 to run a natural language question to first server 204. First server 204 may connect to LLM 212 using a REST API and utilize LLM 212 to translate a given text to SQL through one or more prompts. First server 204 may also connect to vector DB 210 to extract the most relevant columns and values, as well as add/update the values with new values and/or changes to values from queueing/messaging system 208. Once one or more structured queries have been generated, first server 204 may also connect with database 214 to run the structured query, and may also perform periodic runs to fetch relevant column values. These components and their operations of system architecture 200 in FIG. 2 are further described below with regard to FIGS. 3-6.

FIG. 3 is a simplified diagram 300 of the software components executed by the system architecture in FIG. 2 for query generation of structured queries from natural language questions according to some embodiments. Diagram 300 of FIG. 3 represents system architecture 200 from FIG. 2 in further detail with corresponding software operations utilized to resolve user questions in natural language when requesting answers from and/or that rely on data from structured databases. In this regard, diagram 300 shows a flow of handling a user question as may be performed by data search platform 130 of structured data system 120 from environment 100 of FIG. 1.

At an interaction 1, user 202 may initiate a process to ask a free-text question 302 for an answer from a free text to data service 304, which may correspond to a computing service provided by frontend applications 122 and/or data search platform 130. As such, user 202 inputs free-text question 302 in natural language using a natural language search engine, conversational AI, or other system that allows for input in natural language as opposed to a structured language used to query structured databases. A token passed as part of the API may enforce a tenant identifier for free-text question 302 to allow for identification of the corresponding tenant and therefore structured databases and/or data tables for querying, or the tenant identifier may be otherwise passed with free-text question 302. To provide natural language querying on a structured database, a structured data query may be required to be generated, which may be done by free text to data service 304 using LLM 212. At an interaction 2, a first prompt 306 is sent to LLM 212 with free-text question 302 and the bare schema of one or more structured databases to be searched and queried for the corresponding data. First prompt 306 may therefore include free-text question 302 with the database schema (e.g., tables, columns, entities, properties, etc., of the database, as well as columns/properties that have discrete sets of values and may correspond to data strings), as well as an instruction to translate free-text question 302 to a structured query based on the database schema. A response from LLM 212 to free text to data service 304 may include a first structured data query having one or more string literals or other data strings that identify the possible or guessed discrete data values, such as discrete text values for columns and/or properties.

At an interaction 3, free text to data service 304 then parses the first structured data query received from LLM 212 to determine the string literals present, and corresponding discrete data values, that are to be used to query the corresponding structured database for structured data. Free text to data service 304 may perform a vector DB search 308 to identify any semantically close data values to those data values corresponding to the string literals from the query, which may be done by converting the string literals and/or discrete data values to vectors and performing a vector comparison to vectors in a data store 310. Data store 310 may correspond to a vector database that allows for embedding and/or vector searching (e.g., through mathematical comparison processes of mathematical vectors or representations of data). For example, vectors may be computed and/or calculated from the data values to represent the data values in a vector space. The vectors in data store 310 may correspond to mathematical representations of discrete data values stored to data tables of the tenant and/or to be queried based on free-text question 302. As such, free text to data service 304 may retrieve discrete data values from data store 310, where those discrete values are actually stored by the structured database(s) to be searched.

At an interaction 4, free text to data service 304 repeats the process of prompting LLM 212 in a second prompt 312 to generate a structured data query from free-text question 302 using the database schema, but during this iteration of prompting LLM 212, free text to data service 304 augments first prompt 306 to generate second prompt 312. Second prompt 312 may therefore include the data from first prompt 306 (e.g., free-text question 302 with the database schema) with the relevant possible values for the discrete columns from data store 310. In some embodiments, second prompt 312 may also include the first structured data query and/or the discrete values generated by LLM 212 in response to first prompt 306. Free text to data service 304 may receive a second structured data query in response to second prompt 312 that includes the discrete data values.

At an interaction 5, the second structured data query is executed against a database 316, such as a structured database having structured data. Structured search 314 may utilize the second query with a structured query search system to locate corresponding structured data through structured data querying and searching. At an interaction 6, the structured data is then provided, either directly or after using a generative and/or conversational AI to generate a natural language output and/or answer, to user 202 in a response 318. Response 318 may also include the searched discrete values, as well as any other potentially close discrete values to allow the user to determine if refinement and/or rewriting of free-text question 302 is required.

In a corresponding process that may be executed before, during, and/or after interactions 1-6, such as at periodic intervals, continuously or intermittently based on pushed events, and the like, data store 310 may be updated with new discrete data values and/or their corresponding vectors. For example, in one update option, a user 320, such as an administrator of a tenant, may update the possible discrete data values stored to data tables of database 316. This may be updated during a change of those values and/or when new values are added, and the data tables may be re-indexed. In another update option, a scheduled extract, transform, and load (ETL) process may obtain all distinct and discrete data values for columns in data tables in database 316. The list of values from the ETL process may be compared to the known values in data store 310, and if any differences are identified, data store 310 may be updated and re-indexed.

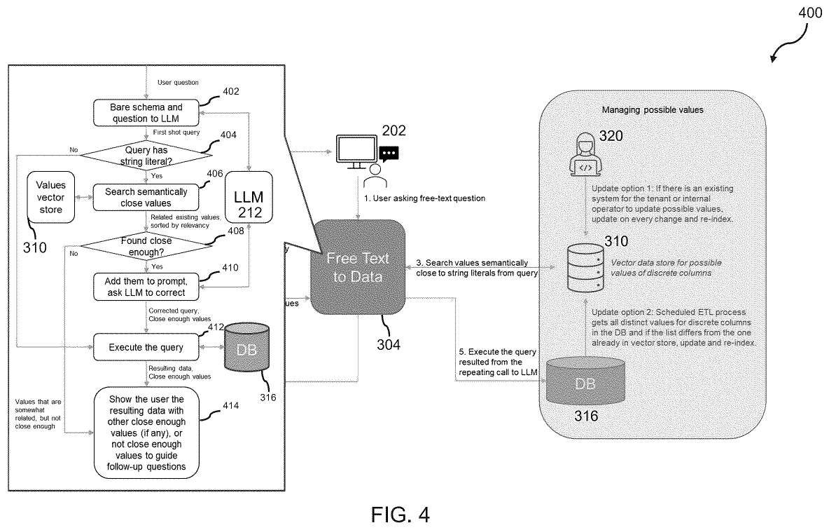

FIG. 4 is a simplified diagram 400 of a processing flow for query generation operations to generate structured queries from natural language questions according to some embodiments. Diagram 400 represents a detailed processing flow executable by free text to data service 304 when converting natural language questions to structured data queries. As such, diagram 400 may be executed for the performance of structured query generation from natural language questions performed by data search platform 130 of structured data system 120, discussed in reference to environment 100 of FIG. 1.

When a user question arrives in natural language from a user 202, the question may be received by free text to data service 304, which may initiate a process shown in steps 402-414. At step 402, the user's question and the database schema (tables, columns, basic descriptions, etc.) are sent to LLM 212 as a prompt, which may include at least the question and database schema with an instruction to generate an initial structured query (e.g., in SQL). The prompt itself can change depending on the persona, the vertical/domain corresponding to the question, and other tenant or user parameters associated with user 202. In this regard, LLM 212 may be specifically prompted to generate the first and/or second structured data query based on a corresponding tenant, database, and/or database schema for a database to be searched, which may depend on user 202 and/or a status or identification for user 202, as well as the free-text question and/or requested answer. As such, the prompt may be generated to be domain-specific and/or tenant-specific, which may cause query generation for particular databases and/or database schemas.

LLM 212 then generates an initial structured query (e.g., SQL) based on the question and schema information. This initial query may contain guessed or predicted values for columns with discrete sets of possible values. At step 404, the initial query generated by the LLM is parsed to extract any string literals corresponding to guessed discrete data values for columns that have discrete sets of allowed values. If no string literals are found, the query may be executed directly to determine whether any data can be returned from the structured data. Where string literals are found, at step 406, data store 310, such as a vector database, is searched for semantically similar values across all discrete value columns for the specific tenant. The search may use different thresholds, such as a strict threshold that returns a list of N closest vectors (values) with a distance less than a strict threshold. These values are considered similar enough to assume these were the values intended by the user, and, as such, may be used for query refinement in a second prompt to LLM 212. With a lenient threshold, the search may return a list of vectors (values) with a distance less than a lenient threshold, which is higher than the strict threshold, but greater than the strict threshold. These values are considered potentially related but not close enough to be assumed to be the intended values. With the lenient threshold, the values may not actually be intended and therefore may not be used for further query refinement. Thus, the values from the strict threshold are identified as close enough at step 408. The values from the lenient threshold are then held for later use with user 202 to narrow or rewrite/revise the question.

Thus, the values from the strict threshold list are used at step 410 to refine the query with the LLM by adding the values to the initial prompt and prompting LLM 212 to correct and/or refine the first structured data query in a second structured data query. During query refinement, a follow-up request to LLM 212 is sent, which provides the original question, the database schema, and the list of relevant discrete values found in the vector data store for the guessed columns. LLM 212 may then generate a refined query, considering the provided possible discrete values relevant for the question. At step 412, the refined query generated by LLM 212 is executed against database 316. Execution of the query may retrieve data from the database 316 responsive to the data values queried. As such, if results are found, the results are sent to the user, at step 414, along with the relevant discrete values from the strict and/or lenient threshold list, sorted by relevance, to assist the user in revising their query if needed.

In contrast, at step 414, if no results are found, the user may be informed, and the relevant discrete values are provided from the lenient threshold list and sorted by relevance as potential alternatives for the user to rephrase their query. This may be provided as a prompt for the user to refine the query, such as “Did you mean this [. . . ]?” with the discrete values inserted. By using two different thresholds, the system may effectively handle different cases, first where the first guessed value(s) by the LLM is/are close enough to the intended value (e.g., the values identified from the strict threshold for query refinement), and second where the guessed value(s) is/are related but not close enough (e.g., the values identified from the lenient threshold, which may be used for suggesting alternative values to the user). This approach may advantageously improve the user experience by providing accurate query refinement when possible and helpful suggestions for rephrasing the query when the initial LLM guess is not close enough to the intended values.

For data store 310, value identification and/or determination from extracted discrete data values may be performed through vector comparison in a vector space. For example, when a guessed value is extracted, the value may be embedded using the same vector embedding technique as the values that have been stored as vectors in the vector store. A similarity search (e.g., K-nearest neighbors (KNN)) may be performed by data store 310 against vector embeddings of discrete data values to find all values whose vector embeddings are semantically close, or similar within a threshold, to the guessed value. The search may be performed with a filter ensuring lookup only within data associated with the current tenant. The similarity search may return a list of rows having the required possible values in their corresponding column. For example, for a data value, a ‘ColumnId’ can then be used to join the ‘Columns’ table, and get the ‘TableName,’ and ‘ColumnName,’ providing context for the matching values. The returned list may contain objects per each column for which semantically similar values have been found. Each such object therefore may have the column name, the table name and the list of possible values for that column.

The possible values in data store 310 may be updated based on different received changes to data values and/or databases. For example, a change may occur in the external system that generates and/or requests storage of data. When user 320 adds, removes, or changes the possible data value with such a system, a corresponding event is published to the messaging queue. An event handler may listen for notifications from the external system when changes occur (e.g., a new skill added for contact center agents), and, upon receiving a notification, the service may update the data values'table based on the new or changed value for the corresponding column identifier in data store 310. If the value is new, a new row may be inserted and a vector embedding calculated and stored. If removed, the row and vector may be removed, and if changed, the value embedding fields may be correspondingly changed. In another update process, a scheduled ETL service may run a scheduled job (e.g., daily, hourly, at a specific schedule time, etc.) to fetch all distinct values in each database for each combination of ‘TenantId,’ ‘TableName,’ ‘ColumnName,’ or the like existing in the vector store. The ETL service may then compare the fetched values with the existing values and may add new values or delete missing values. Since changes may not be apparent, changes may not necessarily be made unless marked for the scheduled job to update.

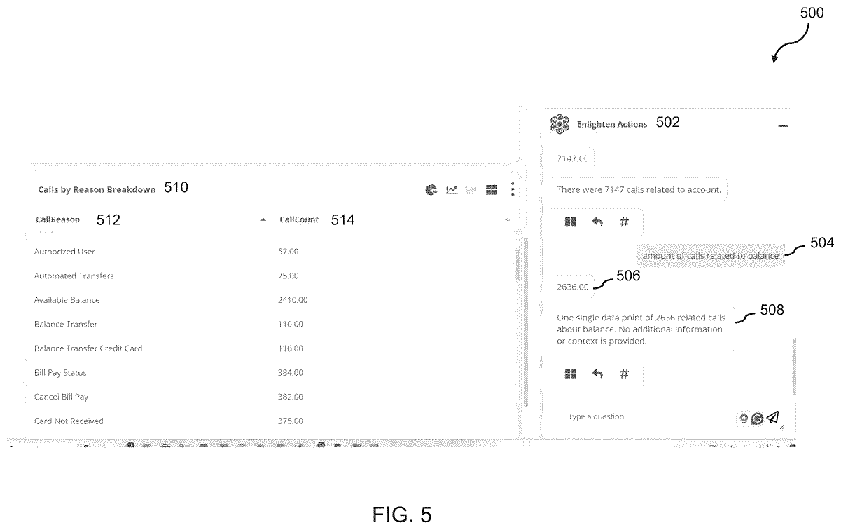

FIG. 5 is a simplified user interface 500 where a user may ask natural language questions for querying a structured database according to some embodiments. In this regard, a user interface 500 may be displayed by application 112 on client device 110, where a user may be asking user question 113 to structured data system 120 as shown in environment 100 of FIG. 1. As such, user interface 500 may correspond to an output of data in application 112 from one or more of frontend applications 122 and/or data search platform 130. User interface 500 therefore includes data and interface elements for processing user question 113 to provide query response 114 based on a conversion to a structured data query.

In user interface 500, application 112 includes an actions window 502 where a current action by a user, such as an agent, administrator, team member or manager, or the like may be processed and handled using a conversational AI, chatbot, and/or other process for responding to user questions. Thus, the user may input a natural language question 504 in actions window 502, which may correspond to a free-text question that requests an answer be provided based on structured data. Using the aforementioned processes for prompting an LLM through multiple prompts and refinement using a data store of discrete data values, a structured data query may be generated and executed on a structured database. As such, a query result may be returned, which may be output in actions window 502 of user interface 500.

Query result 506 may therefore be a query result and returned value from executing the structured data query on the structured database, where the structured data query may be generated from natural language question 504. Query result 506 may be directly provided through actions window 502 but may also be provided in a natural language answer 508, which may be generated using the conversational AI or the like conversing with the user in actions window 502. In this regard, natural language answer 508 may provide an answer to natural language question 504. In some embodiments, additional information may be provided in natural language answer 508, such as the possible discrete values that were used for searching and querying. An additional data window 510 may also be presented, which may provide further information for query result 506 and/or the corresponding structured data. For example, query result 506 may correspond to an aggregation or total queried data values identified in a data table, and, as such, additional data window 510 may include a call breakdown of the aggregated and/or totaled data. For example, additional data window 510 may include a call reason 512 and/or a call count 514 for sub-categories or additional information for the queried data value. In some embodiments, call reason 512 and/or call count 514 may be presented in response to a user selection of query result 506 and/or natural language answer 508. With the expansive view of the data for query result 506, the user may view the structured data from the structured database for interaction and/or analysis.

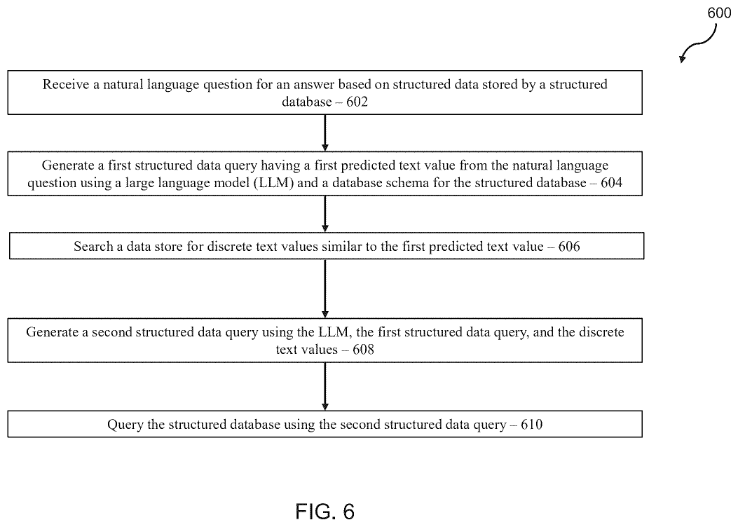

FIG. 6 is a simplified diagram of an exemplary flowchart 600 for converting free-text natural language questions to structured queries using an LLM with discrete text values from a data store according to some embodiments. Note that one or more steps, processes, and methods described herein of flowchart 600 may be omitted, performed in a different sequence, or combined as desired or appropriate based on the guidance provided herein. Flowchart 600 of FIG. 6 includes operations executable by a question processing system to perform data querying and searching of structured databases based on natural language questions received from users, as discussed in reference to FIG. 1-5. One or more of steps 602-610 of flowchart 600 may be implemented, at least in part, in the form of executable code stored on non-transitory, tangible, machine-readable media that when run by one or more processors may cause the one or more processors to perform one or more of steps 602-610. In some embodiments, flowchart 600 can be performed by one or more computing devices discussed in environment 100 of FIG. 1.

At step 602 of flowchart 600, a natural language question is received for an answer to be provided based on structured data stored by a structured database. A question may be received from a user, which may request an answer to be provided based on structured data stored to a structured database or another structured data storage system. However, the question may be received in natural language in place of a structured query, and therefore conversion of the natural language question to a structured data query may be required. A search system may therefore provide a natural language interface, such as through a conversational AI, chatbot, or the like, which may allow for users to directly ask questions in natural language. However, answers may be required to be provided through information stored in a structured data format. For example, question answering systems and applications may be provided and/or used to answer questions by generative AIs using conversational AI skills with a knowledge base that includes structured data. In some embodiments, this may include use of retrieval augmented generation (RAG)-based question-and-answer processes. As such, an efficient and accurate system for querying the structured data may be required.

At step 604 of flowchart 600, a first structured data query having a first predicted text value from the natural language question is generated using an LLM and a database schema for the structured database. The LLM is prompted using one or more API calls with one or more instructions to generate a structured data query in a query language, such as SQL, using the set of data provided with the prompt, as well as any knowledge base or corresponding training data for the LLM. The set of data used for this first prompt may correspond to the natural language question from the user and a database schema for the structured database against which the natural language question is to be queried using a structured data query. The database schema may include a list of data tables stored by the structured database, column identifiers of columns in the data tables, descriptions for the data tables, and the like.

A prompt may be generated from the natural language question and the database schema, as well as an instruction for the LLM to generate a structured data query. The LLM may respond with a structured data question, which may be processed for determination of whether the structured data query is sufficient to execute a structured query on the structured database, or instead requires refinement using a data store of discrete values for the structured database. As such, the first structured data query may include one or more discrete data values, which may correspond to text values for string literals in a query language and/or format for the structured data querying. The discrete data values in the first structured data query may be determined or predicted by the LLM using the natural language question and the database schema, providing a “best guess” or most likely approximation of the data value that the user is requesting be searched for from the structured database.

At step 606 of flowchart 600, a data store is searched for discrete text values similar to the first predicted text value. A vector embedding database or other data store may be used to store vectors or embeddings from words, groups or phrases of words, characters, and the like for the discrete data values in the columns of the data tables in the structured data. The embeddings may correspond to an embedded vector or other mathematical representation of the underlying words and may be used to compare to other embeddings for matching. In this regard, a vector or embedding ML model or the like may be used to generate such vectors or embeddings from the discrete data values. The data store may include a vector or embedding search functionality, which may include one or more comparison algorithms and/or techniques to compare and/or search vectors through an algorithmic comparison operation.

As such, the first structured data query may be parsed and the discrete data values determined by the LLM may be identified. Those may be compared to the discrete data values stored by the data store, and it may be determined if any other semantically similar data values exist. If the same data values exist, which therefore indicates that the discrete data values initially determined are correct and/or exist in the database, the first structured database may be queried directly using that first created query. However, if other semantically similar but different values exist, flowchart 600 may proceed to step 608 where refinement and further generation of a query may be performed using the LLM to better query the structured database. Further, if no semantically similar values are found, the user may be alerted and requested to refine or reform their question for better understanding and searching.

At step 608 of flowchart 600, a second structured data query is generated using the LLM, the first structured data query, and the discrete text values. The second structured data query may be generated by prompting the LLM a second time and/or using one or more second API calls for query generation. The prompt may include an instruction to generate a structured query using a set of data provided and any training and/or knowledge base. As such, the set of data provided may include the natural language question, the database schema, the discrete values from the first structured data query and/or the data store, and/or the first structured data query itself. Further, the instruction in the prompt may require that the LLM utilize one or more of the known discrete data values from the value store such that the second structured data query is generated for existing data values and can be queried on the structured database. As such, a response from the LLM may include the second structured data query that may be used directly with the structured database.

At step 610 of flowchart 600, the structured database is queried using the second structured data query. The structured query may allow for retrieval of structured data that was requested from the user's natural language question. As such, the data retrieval may provide data or a set of structured data that may be responsive to the question and may allow for an application to provide a response to the question via a user interface. The response may be provided in natural language and/or conversational form, such as using a conversational AI and/or the LLM to converse back with the user in the natural language format. The response may be procedurally generated using the structured data returned from the structured data query, and may be generated to be responsive, such as in a conversational manner, to the natural language question. As such, the user may view a response to a question in natural language instead of being required to understand and parse through structured data queries and responses including data views and tables in formatted and structured form.

As discussed above and further emphasized here, FIGS. 1-7 are merely examples of structured data system 120 and corresponding methods for utilizing an LLM with a data store of discrete data values for structured query generation from natural language questions, which said examples should not be used to unduly limit the scope of the claims. One of ordinary skill in the art would recognize many variations, alternatives, and modifications.

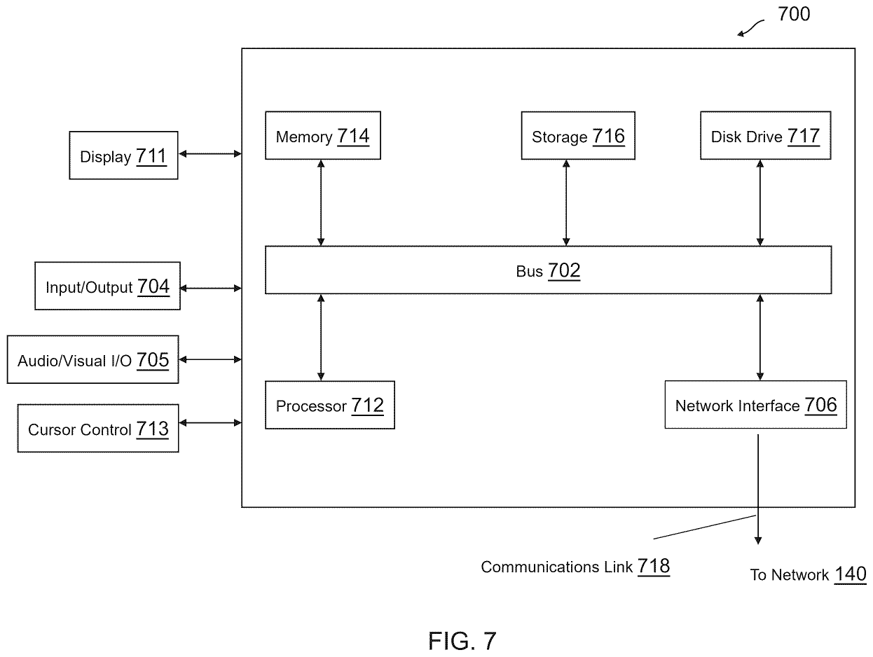

FIG. 7 is a block diagram of a computer system 700 suitable for implementing one or more components in FIG. 1, according to an embodiment. In various embodiments, the communication device may include a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 700 in a manner as follows.

Computer system 700 includes a bus 702 or other communication mechanism for communicating information data, signals, and information between various components of computer system 700. Components include an input/output (I/O) component 704 that processes a user action, such as selecting keys from a keypad/keyboard, selecting one or more buttons, image, or links, and/or moving one or more images, etc., and sends a corresponding signal to bus 702. I/O component 704 may also include an output component, such as a display 711 and a cursor control 713 (such as a keyboard, keypad, mouse, etc.). An optional audio/visual input/output component 705 may also be included to allow a user to use voice for inputting information by converting audio signals. Audio/visual I/O component 705 may allow the user to hear audio, and well as input and/or output video. A transceiver or network interface 706 transmits and receives signals between computer system 700 and other devices, such as another communication device, service device, or a service provider server via network 140. In one embodiment, the transmission is wireless, although other transmission mediums and methods may also be suitable. One or more processors 712, which can be a micro-controller, digital signal processor (DSP), or other processing component, processes these various signals, such as for display on computer system 700 or transmission to other devices via a communication link 718. Processor(s) 712 may also control transmission of information, such as cookies or IP addresses, to other devices.

Components of computer system 700 also include a system memory component 714 (e.g., RAM), a static storage component 716 (e.g., ROM), and/or a disk drive 717. Computer system 700 performs specific operations by processor(s) 712 and other components by executing one or more sequences of instructions contained in system memory component 714. Logic may be encoded in a computer readable medium, which may refer to any medium that participates in providing instructions to processor(s) 712 for execution. Such a medium may take many forms, including but not limited to, non-volatile media, volatile media, and transmission media. In various embodiments, non-volatile media includes optical or magnetic disks, volatile media includes dynamic memory, such as system memory component 714, and transmission media includes coaxial cables, copper wire, and fiber optics, including wires that include bus 702. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 718 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A question processing system configured to intelligently generate structured data queries from natural language questions using a large language model (LLM), the question processing system comprising:
a processor and a non-transitory computer readable medium operably coupled thereto, the non-transitory computer readable medium comprising a plurality of instructions stored in association therewith that are accessible to, and executable by, the processor, to perform query generation operations which comprise:
receiving, via a user interface of an application, a first natural language question for structured data stored by a structured database, wherein the structured data includes one or more columns having discrete text values;
generating, using the LLM based on the first natural language question and a database schema for the structured database, a first structured data query having a first predicted text value determined by the LLM based on the first natural language question;
searching a data store for one or more existing values from the discrete text values that validate the first predicted text value, wherein the data store comprises semantically similar values for the discrete text values, and wherein the searching identifies the one or more existing values from the discrete text values based on a similarity threshold of the semantically similar values to the first predicted text value;
generating, using the LLM based on the first natural language question, the database schema, the one or more existing values from the discrete text values, and the first structured data query, a second structured data query for querying the structured database for the structured data, wherein the second structured data query refines the first structured data query based on the one or more existing values from the discrete text values to include at least one of the first predicted text value or a second predicted text value;
querying the structured database using the second structured data query for a response to the first natural language question based at least on the structured data; and
outputting, in the user interface of the application, the response to the first natural language question.

2. The question processing system of claim 1, wherein the database schema comprises a list of data tables stored by the structured database, column identifiers of the one or more columns of the data tables, and descriptions for the data tables in the list.

3. The question processing system of claim 1, wherein the data store comprises a vector database having vectors representing possible values of the discrete text values usable for queries to the structured database, and wherein, before the searching, the query generation operations further comprise:
determining that the first structured data query includes a string literal corresponding to the first predicted text value.

4. The question processing system of claim 3, wherein the searching comprises:
extracting the string literal for the first predicted text value from the first structured data query;
converting the string literal to a first vector in a vector space; and
comparing the first vector to the vectors representing the possible values in the vector space based on the similarity threshold.

5. The question processing system of claim 4, wherein the similarity threshold utilizes one of a strict threshold or a lenient threshold, wherein the strict threshold causes the comparing to return a first list of n closest vectors of the vectors that are less than or equal to a first preset similarity value of the strict threshold, and wherein the lenient threshold causes the comparing to return to a second list of n closest vectors of the vectors that are less than or equal to a second preset similarity value that is a greater similarity distance than the first preset similarity value, and wherein the second present similarity value is configured to include related text values for the discrete text values.

6. The question processing system of claim 1, wherein the discrete text values comprise at least one of categorical observations, text identifiers, or text descriptions.

7. The question processing system of claim 1, wherein, before outputting the response, the query generation operations further comprise:
receiving a result to the second structured data query based on the querying, wherein the result identifies whether at least one data record having the first predicted text value or the second predicted text value is found based on the querying,
wherein the response includes the result.

8. The question processing system of claim 7, wherein the result identifies that no data record was found based on the querying, and wherein the query generation operations further comprise:
providing a list of the one or more existing values from the discrete text values and a suggestion of a second natural language question usable as an alternative to the first natural language question.

9. The question processing system of claim 1, wherein the generating the first and the second structured data queries using the LLM includes prompting the LLM using a prompt having instructions to generate a structured data query from the first natural language question using at least the database schema and based on a knowledge base of a structured query language and a structured query language syntax.

10. A method to intelligently generate structured data queries from natural language questions using a large language model (LLM) for a question processing system, the method comprising:
receiving, via a user interface of an application, a first natural language question for structured data stored by a structured database, wherein the structured data includes one or more columns having discrete text values;
generating, using the LLM based on the first natural language question and a database schema for the structured database, a first structured data query having a first predicted text value determined by the LLM based on the first natural language question;
searching a data store for one or more existing values from the discrete text values that validate the first predicted text value, wherein the data store comprises semantically similar values for the discrete text values, and wherein the searching identifies the one or more existing values from the discrete text values based on a similarity threshold of the semantically similar values to the first predicted text value;
generating, using the LLM based on the first natural language question, the database schema, the one or more existing values from the discrete text values, and the first structured data query, a second structured data query for querying the structured database for the structured data, wherein the second structured data query refines the first structured data query based on the one or more existing values from the discrete text values to include at least one of the first predicted text value or a second predicted text value;
querying the structured database using the second structured data query for a response to the first natural language question based at least on the structured data; and
outputting, in the user interface of the application, the response to the first natural language question.

11. The method of claim 10, wherein the database schema comprises a list of data tables stored by the structured database, column identifiers of the one or more columns of the data tables, and descriptions for the data tables in the list.

12. The method of claim 10, wherein the data store comprises a vector database having vectors representing possible values of the discrete text values usable for queries to the structured database, and wherein, before the searching, the method further comprises:
determining that the first structured data query includes a string literal corresponding to the first predicted text value.

13. The method of claim 12, wherein the searching comprises:
extracting the string literal for the first predicted text value from the first structured data query;
converting the string literal to a first vector in a vector space; and
comparing the first vector to the vectors representing the possible values in the vector space based on the similarity threshold.

14. The method of claim 13, wherein the similarity threshold utilizes one of a strict threshold or a lenient threshold, wherein the strict threshold causes the comparing to return a first list of n closest vectors of the vectors that are less than or equal to a first preset similarity value of the strict threshold, and wherein the lenient threshold causes the comparing to return to a second list of n closest vectors of the vectors that are less than or equal to a second preset similarity value that is a greater similarity distance than the first preset similarity value, and wherein the second present similarity value is configured to include related text values for the discrete text values.

15. The method of claim 10, wherein the discrete text values comprise at least one of categorical observations, text identifiers, or text descriptions.

16. The method of claim 10, wherein, before outputting the response, the method further comprises:
receiving a result to the second structured data query based on the querying, wherein the result identifies whether at least one data record having the first predicted text value or the second predicted text value is found based on the querying,
wherein the response includes the result.

17. The method of claim 16, wherein the result identifies that no data record was found based on the querying, and wherein the method further comprises:
providing a list of the one or more existing values from the discrete text values and a suggestion of a second natural language question usable as an alternative to the first natural language question.

18. The method of claim 10, wherein the generating the first and the second structured data queries using the LLM includes prompting the LLM using a prompt having instructions to generate a structured data query from the first natural language question using at least the database schema and based on a knowledge base of a structured query language and a structured query language syntax.

19. A non-transitory computer-readable medium having stored thereon computer-readable instructions executable to intelligently generate structured data queries from natural language questions using a large language model (LLM) for a question processing system, the computer-readable instructions executable to perform query generation operations which comprise:
receiving, via a user interface of an application, a first natural language question for structured data stored by a structured database, wherein the structured data includes one or more columns having discrete text values;
generating, using the LLM based on the first natural language question and a database schema for the structured database, a first structured data query having a first predicted text value determined by the LLM based on the first natural language question;
searching a data store for one or more existing values from the discrete text values that validate the first predicted text value, wherein the data store comprises semantically similar values for the discrete text values, and wherein the searching identifies the one or more existing values from the discrete text values based on a similarity threshold of the semantically similar values to the first predicted text value;
generating, using the LLM based on the first natural language question, the database schema, the one or more existing values from the discrete text values, and the first structured data query, a second structured data query for querying the structured database for the structured data, wherein the second structured data query refines the first structured data query based on the one or more existing values from the discrete text values to include at least one of the first predicted text value or a second predicted text value;
querying the structured database using the second structured data query for a response to the first natural language question based at least on the structured data; and
outputting, in the user interface of the application, the response to the first natural language question.

20. The non-transitory computer-readable medium of claim 19, wherein the database schema comprises a list of data tables stored by the structured database, column identifiers of the one or more columns of the data tables, and descriptions for the data tables in the list.
